(19) United States
(12) Patent Application Publication
(10) Pub. No.: US 2018/0227108 A1
(43) Pub. Date: Aug. 9, 2018

(54) COMMUNICATION DATA RATE SELECTION FOR AN ELECTRONIC DEVICE

(71) Applicant: QUALCOMM Incorporated, San Diego, CA (US)

(72) Inventors: Hao Zhu, Milpitas, CA (US); Srinivas Katar, Fremont, CA (US); Xiaolong Huang, San Jose, CA (US); Chao Zou, Milpitas, CA (US); Deniz Rende, San Jose, CA (US)

(21) Appl. No.: 15/424,567

(22) Filed: Feb. 3, 2017

(51) Int. Cl. H04L 5/00

(52) U.S. Cl. CPC H04L 5/0064; H04L 27/2601; H04L 5/006

(57) ABSTRACT

A method includes determining, based on a first packet error rate (PER) associated with a first communication data rate of data sent from a first electronic device to a second electronic device, a predicted second PER associated with a second communication data rate by increasing a value of the predicted second PER based on a first signal-to-noise ratio (SNR) sensitivity associated with the first communication data rate being less than a second SNR sensitivity associated with the second communication data rate or by decreasing the value of the predicted second PER based on the first SNR sensitivity being greater than the second SNR sensitivity. The method further includes selecting a communication data rate for communication from the first electronic device to the second electronic device based at least in part on the first PER and the predicted second PER.

### I. FIELD

This disclosure is generally related to electronic devices and more particularly to electronic devices that communicate using a wireless network.

### II. DESCRIPTION OF RELATED ART

An electronic device may communicate with one or more other electronic devices using a network. For example, a mobile device may use a wireless network to communicate with an access point. The access point may be connected to one or more other networks, such as the Internet.

In some circumstances, a network is subject to noise or interference. For example, wireless signals sent and received by a mobile device may be subject to noise and interference from wireless signals of other mobile devices. Some wireless communication techniques use reference information to estimate noise and interference conditions at a wireless network. For example, the reference information may include “explicit” channel information (e.g., channel sounding information or pilot symbols sent via a pilot channel of the wireless network) to determine channel quality indicator (CQI) data, and an electronic device may use the CQI data to compensate for channel conditions during processing of a received signal.

In some applications, use of CQI data may be inefficient. For example, CQI data may poorly track wireless channel conditions that change rapidly. As another example, communication frequencies may be changed rapidly in some wireless communication techniques. In this case, multiple sets of CQI data may be determined for different communication frequencies due to frequency selectivity of the communication frequencies. Determining multiple sets of CQI data consumes time and device resources.

### SUMMARY

In an illustrative example, a method of selecting a communication data rate from a plurality of communication data rates in an orthogonal frequency division multiple access (OFDMA) wireless system includes determining, based on a first packet error rate (PER) associated with a first communication data rate of data sent from a first electronic device to a second electronic device, a predicted second PER associated with a second communication data rate. Determining the predicted second PER includes increasing a value of the predicted second PER in response to determining that the first PER is greater than a first threshold and based on a first signal-to-noise ratio (SNR) sensitivity associated with the first communication data rate being less than a second SNR sensitivity associated with the second communication data rate or decreasing the value of the predicted second PER in response to determining that the first PER is less than a second threshold and based on the first SNR sensitivity being greater than the second SNR sensitivity. The method further includes selecting the communication data rate for communication from the first electronic device to the second electronic device based at least in part on the first PER and the predicted second PER.

In another illustrative example, an apparatus to select a communication data rate from a plurality of communication data rates in an OFDMA wireless system includes an SNR sensitivity determination circuit configured to determine a first SNR sensitivity associated with a first communication data rate of data sent from a first electronic device to a second electronic device and to determine a second SNR sensitivity associated with a second communication data rate of data sent from the first electronic device to the second electronic device. The apparatus further includes a PER determination circuit coupled to an output of the SNR sensitivity determination circuit. The PER determination circuit is configured to determine, based on a first PER associated with the first communication data rate, a predicted second PER associated with the second communication data rate. The PER determination circuit is further configured to increase a value of the predicted second PER in response to determining that the first PER is greater than a first threshold and based on the first SNR sensitivity being less than the second SNR sensitivity and to decrease the value of the predicted second PER in response to determining that the first PER is less than a second threshold and based on the first SNR sensitivity being greater than the second SNR sensitivity. The apparatus further includes a communication data rate selection circuit coupled to an output of the PER determination circuit. The communication data rate selection circuit is configured to select the communication data rate for communication from the first electronic device to the second electronic device based at least in part on the first PER and the predicted second PER.

In another illustrative example, a computer-readable medium stores instructions executable by a processor to initiate operations to select a communication data rate from a plurality of communication data rates in an OFDMA wireless system. The operations include includes determining, based on a first PER associated with a first communication data rate of data sent from a first electronic device to a second electronic device, a predicted second PER associated with a second communication data rate. Determining the predicted second PER includes either increasing a value of the predicted second PER in response to determining that the first PER is greater than a first threshold and based on a first SNR sensitivity associated with the first communication data rate being less than a second SNR sensitivity associated with the second communication data rate or decreasing the value of the predicted second PER in response to determining that the first PER is less than a second threshold and based on the first SNR sensitivity being greater than the second SNR sensitivity. The operations further include selecting the communication data rate for communication from the first electronic device to the second electronic device based at least in part on the first PER and the predicted second PER.

In another illustrative example, an apparatus to select a communication data rate from a plurality of communication data rates in an OFDMA wireless system includes means for determining a first SNR sensitivity associated with a first communication data rate of data sent from a first electronic device to a second electronic device and for determining a second SNR sensitivity associated with a second communication data rate of data sent from the first electronic device to the second electronic device. The apparatus further includes means for determining, based on a first PER associated with the first communication data rate, a predicted second PER associated with the second communication data rate by increasing a value of the predicted second PER in response to determining that the first PER is greater than a first threshold and based on the first SNR sensitivity being less than the second SNR sensitivity or by decreasing the value of the predicted second PER in response to determining that the first PER is less than a second threshold and based on the first SNR sensitivity being greater than the second SNR sensitivity. The apparatus further includes means for selecting the communication data rate for communication from the first electronic device to the second electronic device based at least in part on the first PER and the predicted second PER.

### IV. BRIEF DESCRIPTION OF THE DRAWINGS

FIG. 1 is a diagram of an illustrative example of a system including an electronic device that is configured to communicate using a plurality of communication data rates based on a plurality of error rates and a target error rate.

FIG. 2 is a diagram illustrating an example of a graph corresponding to a plurality of communication data rates that may be selected by the electronic device of FIG. 1.

FIG. 3 is a diagram illustrating another example of a graph corresponding to a plurality of communication data rates that may be selected by the electronic device of FIG. 1.

FIG. 4 is a diagram illustrating another example of a graph corresponding to a plurality of communication data rates that may be selected by the electronic device of FIG. 1.

FIG. 5 is a diagram illustrating another example of a graph corresponding to a plurality of communication data rates that may be selected by the electronic device of FIG. 1.

FIG. 6 is a block diagram of an illustrative example of a device that may be included in the electronic device of FIG. 1.

FIG. 7 is a flow chart of a method of operation of an electronic device, such as the electronic device of FIG. 1.

FIG. 8 is a block diagram of an illustrative example of an electronic device, such as the electronic device of FIG. 1.

### V. DETAILED DESCRIPTION

Aspects of the disclosure are related to communication data rate selection for an electronic device. In an illustrative example, an electronic device is configured to select a communication data rate that “maximizes” throughput without exceeding a target error rate. The throughput may be determined based on an error rate associated with the communication data rate, such as based on a number of unacknowledged messages indicated from a receiver. The communication data rate may be selected and adjusted stochastically (e.g., based on a number of unacknowledged messages that depends on the particular channel conditions). In a non-limiting illustrative example, the communication data rate may be selected and adjusted without use of “explicit” channel information, which may improve performance of the electronic device in some applications as compared to a device that measures channel conditions using explicit channel information. Other illustrative aspects are described below with reference to the drawings.

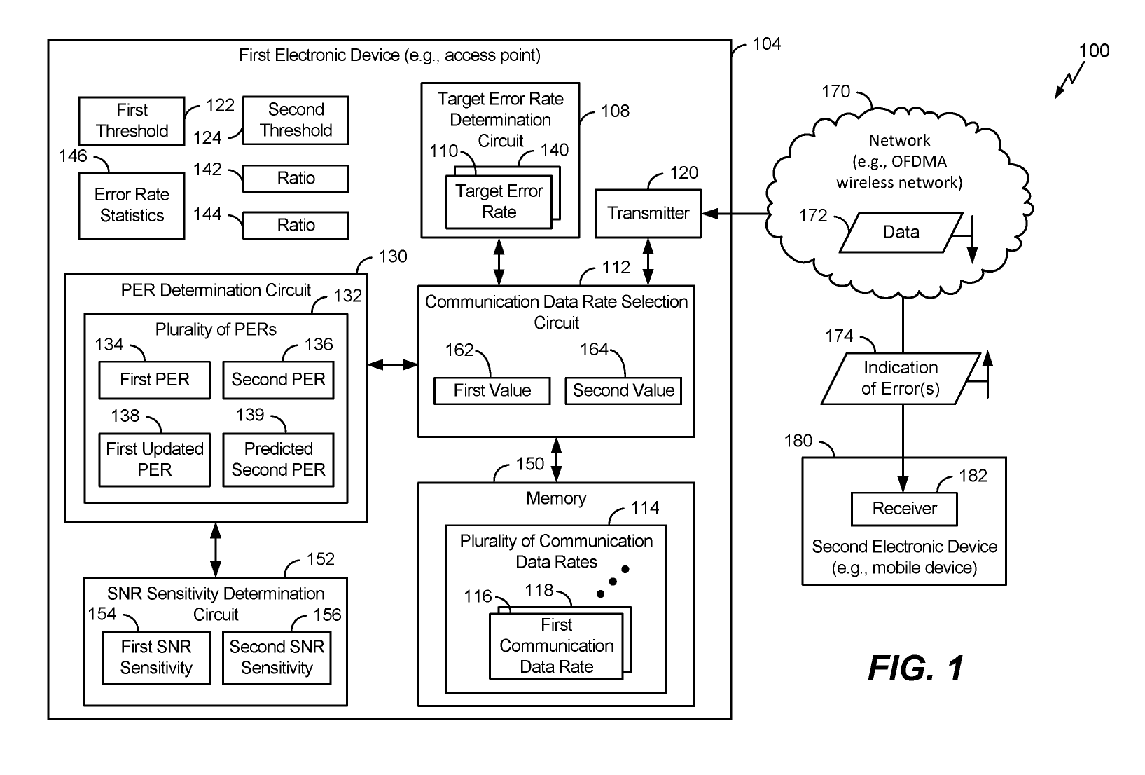

Referring to FIG. 1, an illustrative example of a system is depicted and generally designated 100. The system 100 includes a first electronic device 104 and a second electronic device 180. In an illustrative example, the first electronic device 104 corresponds to an access point, and the second electronic device 180 corresponds to a mobile device. The system 100 may correspond to an orthogonal frequency division multiple access (OFDMA) wireless system.

In the example of FIG. 1, the first electronic device 104 includes a communication data rate selection circuit 112, a packet error rate (PER) determination circuit 130, and a signal-to-noise ratio (SNR) sensitivity determination circuit 152. The PER determination circuit 130 is coupled to an output of the SNR sensitivity determination circuit 152, and the communication data rate selection circuit 112 is coupled to an output of the PER determination circuit 130.

The first electronic device 104 may also include a target error rate determination circuit 108 that is coupled to the communication data rate selection circuit 112. The first electronic device 104 may further include a transmitter 120 coupled to the communication data rate selection circuit 112.

FIG. 1 also illustrates that the first electronic device 104 includes a memory 150 coupled to the communication data rate selection circuit 112. The memory 150 may be configured to store indications of a plurality of communication data rates 114.

The first electronic device 104 may be configured to communicate with the second electronic device 180 using a network 170. To illustrate, the network 170 may include an orthogonal frequency division multiple access (OFDMA) wireless network. The system 100 may optionally include one or more other devices that communicate with the first electronic device 104 using the network 170 simultaneously (e.g., in accordance with an OFDMA communication technique).

The first electronic device 104 may be configured to send data 172 to the second electronic device 180 (e.g., to a receiver 182 of the second electronic device 180) using the network 170. In an illustrative example, the data 172 includes voice-over-Internet-Protocol (VOIP) data, and the network 170 corresponds to a VOIP network (or a channel of a VOIP network). Alternatively or in addition, the data 172 may include other data, such as non-speech data.

The first electronic device 104 is configured to send the data 172 to the second electronic device 180 based on one or more communication data rates of the plurality of communication data rates 114. To illustrate, the plurality of communication data rates 114 may include a first communication data rate 116 and a second communication data rate 118. Use of the first communication data rate 116 may result in a different speed of data transmission as compared to the second communication data rate 118. For example, sending the data 172 using the first communication data rate 116 may result in faster (or slower) transmission of the data 172 as compared to using the second communication data rate 118. Each communication data rate of the plurality of communication data rates 114 may correspond to a particular number of bits per second (b/s) of a physical (PHY) communication data rate, such as a particular number of megabits per second (Mbps) of a PHY communication data rate, as an illustrative example.

Each communication data rate of the plurality of communication data rates 114 may be associated with a corresponding error rate, such as packet error rate (PER). To illustrate, the plurality of communication data rates 114 may be associated with a plurality of PERs 132. In some cases, a higher communication data rate may be associated with an increased number of errors (and a greater error rate) as compared to other communication data rates. The first communication data rate 116 may be associated with a first PER 134, and the second communication data rate 118 may be associated with a second PER 136.

The PER determination circuit 130 is configured to determine the plurality of PERs 132, such by detecting (e.g., “measuring”) error rates associated with the plurality of communication data rates 114. The PER determination circuit 130 may be configured to determine the plurality of PERs 132 based on a number of acknowledged (ACKed) messages indicated from the second electronic device 180, based on a number of unacknowledged messages indicated from the second electronic device 180, or a combination thereof.

The SNR sensitivity determination circuit 152 is configured to determine a first SNR sensitivity 154 associated with the first communication data rate 116 and to determine a second SNR sensitivity associated with the second communication data rate 118. The first SNR sensitivity 154 may indicate susceptibility of the first communication data rate 116 to channel conditions (e.g., fading) associated with the network 170, and the second SNR sensitivity 156 may indicate susceptibility of the second communication data rate 118 to channel conditions (e.g., fading) associated with the network 170. For example, if the second SNR sensitivity 156 is greater than the first SNR sensitivity 154 and if the first PER 134 is relatively large, then the first electronic device 104 may determine (e.g., predict) that use of the second communication data rate 118 is likely to result in a relatively large number of errors. As a result, the first electronic device 104 may predictively increase the second PER 136 to determine a predicted second PER 139 (based on the first SNR sensitivity 154, the second SNR sensitivity 156, and the first PER 134). As another example, if the second SNR sensitivity 156 is less than the first SNR sensitivity 154 and if the first PER 134 is relatively small, then the first electronic device 104 may determine (e.g., predict) that use of the second communication data rate 118 is unlikely to result in a relatively large number of errors. In this example, the first electronic device 104 may predictively decrease the second PER 136 to determine the predicted second PER 139 (based on the first SNR sensitivity 154, the second SNR sensitivity 156, and the first PER 134).

In some implementations, the second electronic device 180 may provide an indication of one or more of the SNR sensitivities 154, 156 to the first electronic device 104. For example, the second electronic device 180 may provide an indication of the first SNR sensitivity 154 (or an SNR associated with the first SNR sensitivity 154) to the first electronic device 104 upon receiving the data 172 sent at the first communication data rate 116. As another example, the second electronic device 180 may provide an indication of the second SNR sensitivity 156 (or an SNR associated with the second SNR sensitivity 156) to the first electronic device 104 upon receiving the data 172 sent at the second communication data rate 118. Alternatively or in addition, the second electronic device 180 may determine one or more of the SNR sensitivities 154, 156. For example, in some implementations, the SNR sensitivity determination circuit 152 may be configured to determine the SNR sensitivities 154, 156 based on a number of ACKed messages indicated from the second electronic device 180, a number of unacknowledged messages indicated from the second electronic device 180, or a combination thereof.

During operation, the first electronic device 104 may determine a particular communication data rate for communications with the second electronic device 180, such as by selecting the particular communication data rate from the plurality of communication data rates 114.

The first electronic device 104 may be configured to select the particular communication data rate based on one or more error rates of the plurality of PERs 132 and further based on a target error rate 110. The target error rate 110 may correspond to a “maximum” (or “ceiling”) error rate associated with communications with the second electronic device 180.

To further illustrate, the communication data rate selection circuit 112 may be configured to select a particular communication data rate r according to Equation 1:

max_{r∈R}r*(1−PER(r)) such that PER(r)≤targetPER (Equation 1).

In Equation 1, R may indicate the plurality of communication data rates 114. PER(r) may indicate a PER associated with the particular communication data rate r, such as the first PER 134 that is associated with the first communication data rate 116. In Equation 1, targetPER may indicate the target error rate 110. It is noted that the example of Equation 1 is illustrative and that other techniques are also within the scope of the disclosure.

To further illustrate, the communication data rate selection circuit 112 may be configured to receive (or to access) an indication of the target error rate 110 from the target error rate determination circuit 108. The communication data rate selection circuit 112 may be configured to receive (or to access) an indication of the plurality of PERs 132 from the PER determination circuit 130. In an illustrative example, the communication data rate selection circuit 112 may be configured to select, from the set of PERs 132, a subset of error rates that are less than or equal the target error rate 110 (e.g., to satisfy PER(r)≤targetPER, as in Equation 1). The communication data rate selection circuit 112 may be configured to select, from the subset, an error communication data rate associated with a particular value of a metric, where the particular value is greater than other values of the metric for other communication data rates of the subset. In an illustrative example, the metric corresponds to r*(1−PER(r)), where PER(r)≤targetPER, as in Equation 1. In a particular example, the communication data rate selection circuit 112 is configured to select the first communication data rate 116 based on a comparison of a first value 162 of the metric to a second value 164 of the metric. To further illustrate, in a particular example, the first value 162 is based on the first communication data rate 116, the first PER 134, and the target error rate 110, and the second value 164 is based on the second communication data rate 118, the second PER 136, and the target error rate 110. The first value 162 may indicate an estimated data throughput associated with communicating using the first communication data rate 116, and the second value 164 may indicate an estimated data throughput associated with communication using the second communication data rate 118.

To further illustrate, if the first PER 134 and the second PER 136 are each less than the target error rate 110, then the subset may include the first PER 134 and the second PER 136. Upon identifying the subset, the communication data rate selection circuit 112 may be configured to perform a comparison of values of the metric, such by comparing the first value 162 to the second value 164. For example, the communication data rate selection circuit 112 may be configured to compare the first value 162 to the second value 164. In this example, the communication data rate selection circuit 112 may be configured to select the first communication data rate 116 based on a determination that the first value 162 is greater than the second value 164.

The first electronic device 104 is configured to send data to the second electronic device 180 based on a selected communication data rate. For example, in response to selecting the first communication data rate 116, the first electronic device 104 may send the data 172 to the second electronic device 180 using the transmitter 120 based on the first communication data rate 116.

In some implementations, the first electronic device 104 is configured to determine the target error rate 110 based on one or more criteria. For example, the first electronic device 104 may be configured to determine the target error rate 110 to enable a particular reliability associated the data 172, such as by decreasing the target error rate 110 to increase reliability associated with sending the data 172 to the second electronic device 180. Alternatively or in addition, the first electronic device 104 may be configured to determine the target error rate 110 to enable a particular throughput associated with the data 172 (e.g., by increasing the target error rate 110 to increase throughput associated with sending the data 172 to the second electronic device 180). Alternatively or in addition, the target error rate 110 may be specified by a wireless communication protocol associated with the network 170 or may be requested by the second electronic device 180 (e.g., during a “handshake” procedure).

The first electronic device 104 may be configured to perform an adaptive rate selection process that includes selecting communication data rates of the plurality of communication data rates 114. In an illustrative example, the first electronic device 104 is configured to select a communication data rate of the plurality of communication data rates 114 (e.g., based on Equation 1) in response to a threshold time duration since previously selecting a communication data rate, in response to sending a threshold number of data packets, in response to one or more other criteria, or a combination thereof.

The adaptive rate selection process may enable selection of communication data rates of the plurality of communication data rates 114 to compensate for changing channel conditions associated with the network 170. For example, the adaptive rate selection process may enable the first electronic device 104 to select a reduced communication data rate in response to poorer channel conditions in order to increase reliability of data transmission. As another example, the adaptive rate selection process may enable the first electronic device 104 to select a greater communication data rate in response to improved channel conditions in order to increase throughput of data transmission.

During the adaptive rate selection process, the first electronic device 104 may change from communicating using a particular communication data rate (also referred to herein as a “current communication data rate”) to use another communication data rate (also referred to herein as a “target communication data rate”). For example, the first electronic device 104 may change from communicating the first communication data rate 116 to use the second communication data rate 118 upon selecting the second communication data rate 118 (e.g., in accordance with the example of Equation 1).

In some cases, the first electronic device 104 is configured to update the target error rate 110 in response to a change from a current communication data rate to the target communication data rate. To illustrate, the first electronic device 104 may be configured to adjust the target error rate 110 to a second target error rate 140 in response to changing from communicating using the first communication data rate 116 to communicating using the second communication data rate 118.

In a first illustrative example, the first electronic device 104 may be configured to determine a ratio 142 of first PER 134 and the second PER 136 and to determine the second target error rate 140 based on the ratio 142. For example, the first electronic device 104 may be configured to determine the second target error rate 140 based on Equation 2:

PER_{target}_{_}ᵣₐₜₑ=PER_{current}_{_}ᵣₐₜₑ*ƒ(R_{target}_{_}ᵣₐₜₑ/R_{current}_{_}ᵣₐₜₑ) (Equation 2).

In the example of Equation 2, PER_{target}_{_}ᵣₐₜₑ may indicate the second target error rate 140, and PER_{current}_{_}ᵣₐₜₑ may indicate the target error rate 110. Further, R_{target}_{_}ᵣₐₜₑ may indicate an error rate of a target communication data rate (e.g., the second PER 136 of the second communication data rate 118), R_{current}_{_}ᵣₐₜₑ may indicate an error rate of a current communication data rate (e.g., the first PER 134 of the first communication data rate 116), and ƒ may indicate a function of the ratio 142 selected based on the particular application. In an illustrative example, the function ƒ of Equation 2 may be selected so that the second target error rate 140 is proportional to the ratio 142 (e.g., the function ƒ may indicate a linear relation between the second target error rate 140 and the ratio 142).

In a second illustrative example, the first electronic device 104 may be configured to determine a ratio 144 of a first signal-to-noise ratio (SNR) sensitivity associated with the first communication data rate 116 and a second SNR sensitivity associated with the second communication data rate 118 and to determine the second target error rate 140 based on the ratio 144. For example, the first electronic device 104 may be configured to determine the second target error rate 140 based on Equation 3:

PER_{target}_{_}ᵣₐₜₑ=PER_{current}_{_}ᵣₐₜₑ*ƒ(SNR_{target}_{_}ᵣₐₜₑ/SNR_{current}_{_}ᵣₐₜₑ) (Equation 3).

In the example of Equation 3, PER_{target}_{_}ᵣₐₜₑ may indicate the second target error rate 140, and PER_{current}_{_}ᵣₐₜₑ may indicate the target error rate 110. Further, SNR_{target}_{_}ᵣₐₜₑ may indicate an SNR sensitivity associated with a target communication data rate (e.g., the second SNR sensitivity associated with the second communication data rate 118), SNR_{current}_{_}ᵣₐₜₑ may indicate an SNR sensitivity associated with a current communication data rate (e.g., the first SNR sensitivity associated with the first communication data rate 116), and ƒ may indicate a function of the ratio 144 selected based on the particular application. In an illustrative example, the function ƒ of Equation 3 may be selected so that the second target error rate 140 is proportional to the ratio 142 (e.g., the function ƒ may indicate a linear relation between the second target error rate 140 and the ratio 142).

In a third example, a target error rate may be adjusted based on error rate statistics 146 associated with the target error rate. For example, the error rate statistics 146 may indicate a weighted average (e.g., a time-weighted), a non-weighted average, a moving average, or another average of a plurality of target error rates that includes at least the target error rate 110. In a particular example, the second target error rate 140 is determined based on the error rate statistics 146. As an illustrative example, if the error rate statistics 146 indicates that use of the second target error rate 140 (e.g., in connection with Equation 1) is associated with a relatively high (or relatively low) error rate, then the second target error rate 140 may be assigned a lower (or greater) weight in the error rate statistics 146.

The adaptive rate selection process may include determining an updated error rate, such as a first updated PER 138 associated with the first communication data rate 116. To illustrate, upon sending the data 172 to the second electronic device 180 using the first communication data rate 116, the second electronic device 180 may generate an indication 174 of one or more errors associated with sending the data 172 from the first electronic device 104 to the second electronic device 180. For example, the indication 174 may include one or more unacknowledged messages indicated from the second electronic device 180 to the first electronic device 104 in response to the second electronic device 180 receiving the data 172. The first electronic device 104 may re-determine (e.g., re-calculate or “update”) the first PER 134 based on one or more errors identified by the indication 174 to determine the first updated PER 138.

The adaptive rate selection process may further include modifying one or more error rates of one or more communication data rates of the plurality of communication data rates 114 based on the first PER 134 (or based on the first updated PER 138 after updating the first PER 134). For example, if the first PER 134 is relatively low (e.g., is “better than expected”), then the first electronic device 104 may decrease the second PER 136 in some circumstances to determine the predicted second PER 139 (e.g., to reflect that the second PER 136 is likely to be “better than expected” due to current channel conditions). As another example, if the first PER 134 is relatively high (e.g., is “worse than expected”), then the first electronic device 104 may increase the second PER 136 in some circumstances to determine the predicted second PER 139 (e.g., to reflect that the second PER 136 is likely to be “worse than expected” due to current channel conditions).

To further illustrate, the PER determination circuit 130 may be configured to increase the second PER 136 to determine the predicted second PER 139 in response to the first PER 134 (or the first updated PER 138) satisfying (e.g., being greater than or being greater than or equal to) a first threshold 122 (e.g., an “upper” threshold). In this case, the first PER 134 may be relatively high due to relatively poor channel conditions (e.g., noise or interference) at the network 170. In some implementations, the PER determination circuit 130 is configured to selectively increase error rates that satisfy a first SNR sensitivity criterion. For example, the first communication data rate 116 may be associated with a first SNR sensitivity 154, and the PER determination circuit 130 may be configured to increase the second PER 136 to determine the predicted second PER 139 if a second SNR sensitivity 156 associated with the second communication data rate 118 is greater than the first SNR sensitivity 154. In some implementations, the first SNR sensitivity criterion may enable the first electronic device 104 to avoid increasing the second PER 136 if the second PER 136 is relatively unlikely to be affected by poor channel conditions of the network 170.

Alternatively or in addition, the PER determination circuit 130 may be configured to decrease the second PER 136 in response to the first PER 134 failing to satisfy (e.g., being less than or being less than or equal to) a second threshold 124 (e.g., a “lower” threshold). In this case, the first PER 134 may be relatively low due to relatively favorable channel conditions at the network 170. In some implementations, the PER determination circuit 130 is configured to selectively decrease error rates that satisfy a second SNR sensitivity criterion. For example, the PER determination circuit 130 may be configured to decrease the second PER 136 if the second SNR sensitivity 156 is less than the first SNR sensitivity 154. In some implementations, the second SNR sensitivity criterion may enable the first electronic device 104 to avoid decreasing the second PER 136 if the second PER 136 is relatively unlikely to be affected by favorable channel conditions of the network 170.

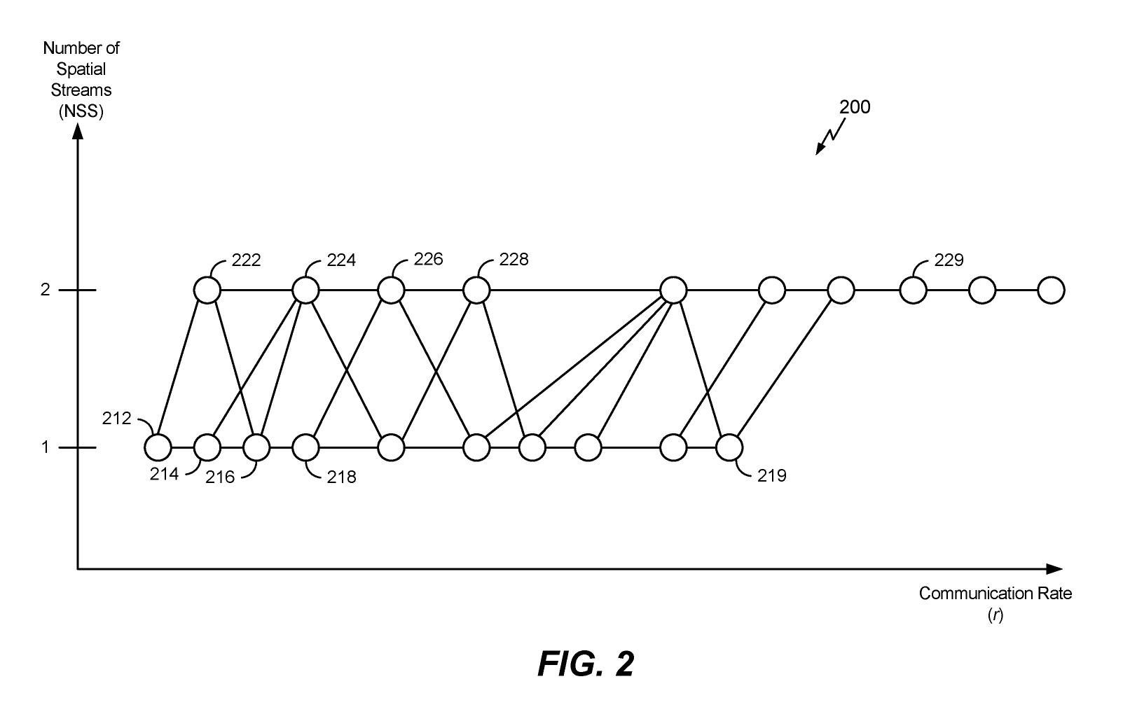

Alternatively or in addition to the second SNR sensitivity criterion, the PER determination circuit 130 may be configured to selectively decrease error rates that satisfy an adjacency criterion. For example, the PER determination circuit 130 may be configured to decrease the second PER 136 if a node associated with the second communication data rate 118 is adjacent to a node associated with the first communication data rate 116 in a graph representing the plurality of communication data rates 114. A graph representing the plurality of communication data rates 114 is described further with reference to FIG. 2.

Values of the first threshold 122 and the second threshold 124 may be determined based on the particular application. In a non-limiting illustrative example, the first threshold 122 may correspond to a 50 percent error rate, and the second threshold 124 may correspond to a 5 percent error rate. In other examples, the first threshold 122 and the second threshold 124 may correspond to different values.

Further, values of one or more of the first threshold 122 or the second threshold 124 may be modified during operation of the first electronic device 104 (e.g., based on the error rate statistics 146). As an illustrative example, the second threshold 124 may be adjusted based on the second PER 136. To illustrate, r1 may indicate the first communication data rate 116, and r2 may indicate the second communication data rate 118. PER(r1) may indicate the first PER 134, and PER(r2) may indicate the second PER 136. If Prob(low PER(r2)|low PER(r1)) is relatively high, then the second threshold 124 may be increased (e.g., as a function of r2−r1, as a function of Prob(low PER(r2)|low PER(r1)), or as a function of both.

In some implementations, one or more aspects described with reference to FIG. 1 may be implemented at the first electronic device 104 using an “open loop” technique. For example, the first electronic device 104 may adjust a communication data rate based on the indication 174 without using “explicit” channel information, such as channel quality indicator (CQI) data. In other examples, one or more aspects described with reference to FIG. 1 may be used in connection with “explicit” channel information, such as CQI data.

In some implementations, the data 172 may include one or more protocol data units (PDUs), such as one or more physical layer conformance procedure protocol data units (PPDUs). A PDU or a PPDU may be specified by a wireless communication protocol, such as an Institute of Electrical and Electronics Engineers (IEEE) 802.11 wireless protocol. Each PPDU may be sent from the first electronic device 104 to the second electronic device 180 using one or more frequencies, such as sub-carrier frequencies of a spectrum of carrier frequencies of the network 170.

Data (e.g., a PPDU) may be sent using a resource unit (RU) selected from a set of RUs that correspond to a set of sub-carrier frequencies (e.g., as specified by an OFDMA communication scheme). The set of RUs may correspond to the set of communication data rates 114. For example, each RU of the set of RUs may correspond to a respective communication data rate of the plurality of communication data rates 114, such as if a first RU of the set of RUs corresponds to the first communication data rate 116 and if a second RU of the set of RUs corresponds to the second communication data rate 118. In an illustrative example, the first electronic device 104 is configured to randomly or pseudo-randomly select RUs of the set of RUs for use in transmission of data to a set of electronic devices in connection with an OFDMA communication scheme. Because different frequencies associated with the set of RUs may have different characteristics (e.g., different frequency selectivity), randomly or pseudo-randomly selecting from among the set of RUs may cause varying effects on data sent and received via the network 170, such as the data 172.

By selecting from among the communication data rates 114 based on the target error rate 110 and a “measured” error rate (e.g., the first PER 134), the first electronic device 104 may detect changes in channel conditions (e.g., as a result of changing RUs). In some applications, the changes may be detected more rapidly or more effectively as compared to use of explicit channel information, such as CQI data.

Referring to FIG. 2, an illustrative example of a graph is depicted and generally designated 200. In FIG. 2, the abscissa of the graph 200 may indicate one or more of the plurality of communication data rates 114 of FIG. 1 or the communication data rate r of Equation 1, and the ordinate of the graph 200 may indicate a particular number of spatial streams (NSS) that may be used by the first electronic device 104 (e.g., to send the data 172 to the second electronic device 180).

Each node of the graph 200 may be associated with a particular communication data rate of the plurality of communication data rates 114 of FIG. 1. In FIG. 2, a first subset of nodes is associated with one spatial stream (NSS=1). For example, nodes 212, 214, 216, 218, and 219 are associated with one spatial stream. A second subset of nodes is associated with two spatial streams (NSS=2). For example, nodes 222, 224, 226, 228, and 229 are associated with two spatial streams.

In some implementations, different rates of graph 200 (and of the plurality of communication data rates 114 of FIG. 1) are enabled using different modulation and coding schemes (MCSs). In this case, the abscissa of the graph 200 may correspond to an MCS index. For example, a rate corresponding to the nodes 214, 222 may be enabled using an MCS that is different than an MCS associated with a rate corresponding to the node 212.

The first electronic device 104 of FIG. 1 may be configured to perform an adaptive rate selection process based on the graph 200. For example, during operation, the first electronic device 104 may iteratively “traverse” the graph 200 based on Equation 1 to select one or more communication data rates of the plurality of communication data rates 114 of FIG. 1. The first electronic device 104 may be configured to select a particular communication data rate based on one or more of a particular NSS (the ordinate of the graph 200) or a particular MCS (the abscissa of FIG. 2).

As used herein, communication data rates corresponding to two nodes in the graph 200 are “adjacent” if a line in the graph 200 connects the two nodes. For example, a communication data rate corresponding to the node 212 is adjacent to a communication data rate corresponding to the node 214 and to a communication data rate corresponding to the node 222. As another example, a communication data rate corresponding to the node 222 is adjacent to a communication data rate corresponding to the node 212, to a communication data rate corresponding to the node 216, and to a communication data rate corresponding to the node 224. To further illustrate, the nodes 218, 224 may be associated with a same communication data rate and may be non-adjacent.

In some examples, the first electronic device 104 of FIG. 1 is configured to perform certain operations based on adjacent communication data rates indicated by the graph 200. For example, referring again to the adjacency criterion described with reference to FIG. 1, the PER determination circuit 130 may be configured to decrease the second PER 136 if the second communication data rate 118 is adjacent to the first communication data rate 116 in the graph 200. In a particular example, the first communication data rate 116 is selected from the plurality of communication data rates 114 indicated by the graph 200.

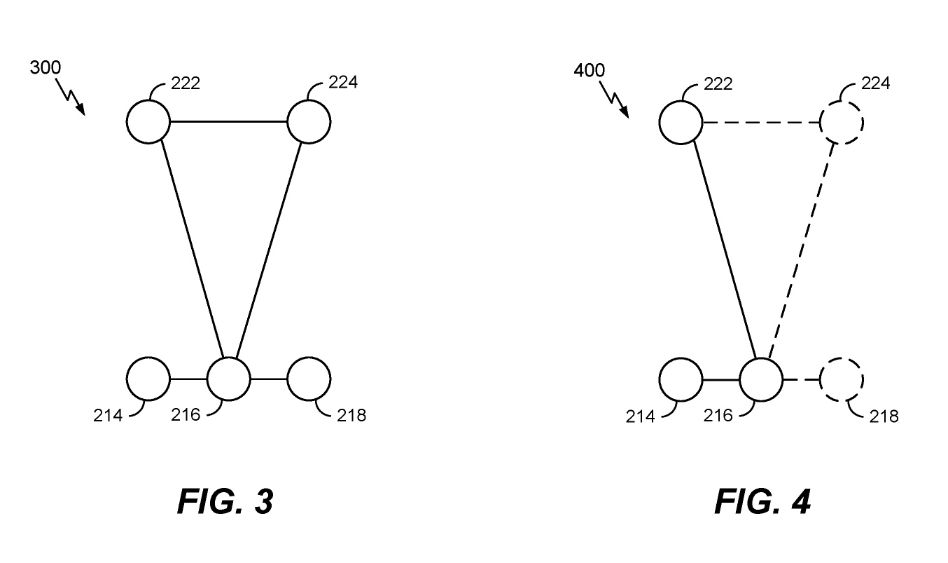

The graph 200 may facilitate communication data rate selection by the first electronic device 104 of FIG. 1. For example, as described with reference to FIGS. 3 and 4, the first electronic device 104 may change from a communication data rate associated with a particular node of the graph 200 to a communication data rate associated with another node that is adjacent to the particular node.

Referring to FIG. 3, an illustrative example of a graph is depicted and generally designated 300. One or more aspects of the graph 300 may be as described with reference to the graph 200 of FIG. 2. For example, the graph 300 includes the nodes 214, 216, 218, 222, and 224. The node 216 is adjacent to the node 214 and to the node 218, and the node 222 is adjacent to the node 224. Each node of the graph 300 may correspond to a particular communication data rate of the plurality of communication data rates 114 of FIG. 1.

In a particular example, the graph 300 indicates a rate selection operation performed by the first electronic device 104 when an error rate of a current communication data rate is less than the target error rate 110. To illustrate, in the example of FIG. 3, the node 216 may correspond to a current communication data rate used by the first electronic device 104, such as the first communication data rate 116. In this example, if the first updated PER 138 associated with the first communication data rate 116 is less than the target error rate 110, the first electronic device 104 may initiate the rate selection operation based on the graph 300 (e.g., in order to increase throughput associated with sending the data 172 to the second electronic device 180).

Depending on the particular example, a current communication data rate may be changed to a target communication data rate that is greater than or less than the current communication data rate. To illustrate, in response to determining that an error rate of a current communication data rate corresponding to the node 216 is less than the target error rate 110, the first electronic device 104 may “sample” (or “iterate”) communication data rates corresponding to nodes that are adjacent to the node 216 in the graph 300, such as communication data rates corresponding to the nodes 214, 218, 222, and 224 (e.g., by consecutively using communication data rates corresponding to the nodes 214, 218, 222, and 224 to send the data 172 to the second electronic device 180). The first electronic device 104 may detect error rates associated with the communication data rates corresponding to the nodes 214, 218, 222, and 224 (e.g., based error rates identified by the indication 174).

The first electronic device 104 may select a particular communication data rate of the communication data rates corresponding to the nodes 214, 216, 218, 222, and 224 based on the error rates. For example, the first electronic device 104 may select the particular communication data rate (from the communication data rates corresponding to the nodes 214, 216, 218, 222, and 224) having a greater throughput or expected throughput than the other communication data rates corresponding to the nodes 214, 216, 218, 222, and 224 and having an error rate that does not exceed the target error rate 110 (e.g., so that PER(r)<targetPER, as in the example of Equation 1).

The example of FIG. 3 illustrates that a current communication data rate (e.g., the first communication data rate 116) may be changed to a target communication data rate (e.g., the second communication data rate 118) in response to an error rate of the current communication data rate being less than the target error rate 110. Depending on the particular example, the current communication data rate may be greater than the target communication data rate or may be less than the target communication data rate.

Referring to FIG. 4, an illustrative example of a graph is depicted and generally designated 400. In the example of FIG. 4, an error rate of a current communication data rate (e.g., a communication data rate corresponding to the node 216) may be greater than the target error rate 110 (e.g., instead of being less than the target error rate 110, as described with reference to the graph 300 of FIG. 3).

To illustrate, in the example of FIG. 4, the node 216 may correspond to a current communication data rate used by the first electronic device 104, such as the first communication data rate 116. In this example, if the first updated PER 138 associated with the first communication data rate 116 is greater than the target error rate 110, the first electronic device 104 may initiate a rate selection operation based on the graph 400 (e.g., in order to decrease an error rate associated with sending the data 172 to the second electronic device 180).

In the example of FIG. 4, a current communication data rate may be changed to a target communication data rate that is less than the current communication data rate. To illustrate, in response to determining that an error rate of a current communication data rate corresponding to the node 216 is greater than the target error rate 110, the first electronic device 104 may “sample” (or “iterate”) communication data rates corresponding to nodes that are adjacent to the node 216 and that are less than the current communication data rate, such as communication data rates corresponding to the nodes 214 and 222 (e.g., by consecutively using communication data rates corresponding to the nodes 214 and 222 to send the data 172 to the second electronic device 180). In the example of the graph 400, communication data rates corresponding to the nodes 218, 224 may be “disqualified” from consideration (represented in FIG. 4 using dashed lines), since for example the communication data rates corresponding to the nodes 218, 224 may be associated with higher error rates than an error rate associated with the node 216. The first electronic device 104 may detect error rates associated with the communication data rates corresponding to the nodes 214 and 222 (e.g., based error rates identified by the indication 174).

The first electronic device 104 may select a particular communication data rate of the communication data rates corresponding to the nodes 214, 216, and 222 based on the error rates. For example, the first electronic device 104 may select the particular communication data rate (from the communication data rates corresponding to the nodes 214, 216, and 222) having a greater throughput or expected throughput than the other communication data rates corresponding to the nodes 214, 216, and 222 and having an error rate that does not exceed the target error rate 110 (e.g., so that PER(r)<targetPER, as in the example of Equation 1).

The example of FIG. 4 illustrates that a current communication data rate (e.g., the first communication data rate 116) may be changed to a target communication data rate (e.g., the second communication data rate 118) in response to an error rate of the current communication data rate being greater than the target error rate 110. In the example of FIG. 4, the current communication data rate may be greater than the target communication data rate (and target communication data rates that are greater than the current communication data rate may be “disqualified” from consideration).

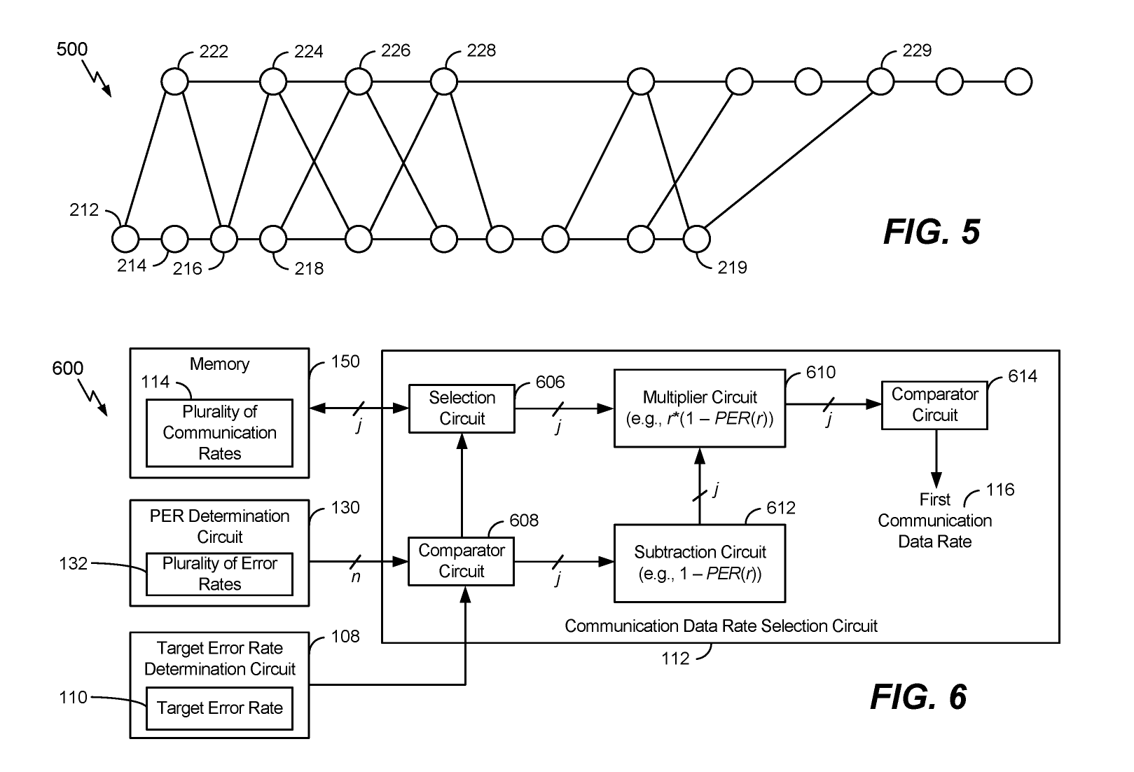

Referring to FIG. 5, another illustrative example of a graph is depicted and generally designated 500. In FIG. 5, the graph 200 of FIG. 2 has been adjusted (e.g., by the first electronic device 104 of FIG. 1) to generate the graph 500.

To illustrate, in FIG. 5, a connection between the nodes 214, 224 has been removed (relative to the graph 200 of FIG. 2). As a result, the node 214 is non-adjacent to the node 224 in the graph 500. As another example, in FIG. 5, a connection between the nodes 219, 229 has been formed (relative to the graph 200 of FIG. 2). As a result, the node 219 is adjacent to the node 229 in the graph 500.

In some implementations, the first electronic device 104 is configured to adjust the graph 200 to generate the graph 500 in response to one or more measured error rates associated with the plurality of communication data rates 114. The one or more measured error rates may be indicated by the error rate statistics 146 of FIG. 1. In a particular example, the graph 500 indicates nodes associated with communication data rates r1, r2, and r3, and the error rate statistics 146 indicate that a low error rate of r1 is correlated with a low error rate of r2 and that a low error rate of r2 is correlated with a low error rate of r3. In this case, the first electronic device 104 may remove a connection between nodes corresponding to the rates r1 and r3 (e.g., so that r1 is no longer adjacent to r3).

The example of FIG. 5 illustrates that the graph 200 of FIG. 2 may be modified based on runtime statistics and channel conditions. As a result, performance at the first electronic device 104 may be enhanced.

Referring to FIG. 6, an illustrative example of a device is depicted and generally designated 600. One or more features of the device 600 may be as described with reference to the first electronic device 104 of FIG. 1. For example, the device 600 may include the PER determination circuit 130, the communication data rate selection circuit 112, the target error rate determination circuit 108, and the memory 150.

The communication data rate selection circuit 112 may include a selection circuit 606 coupled to the memory 150 and may also include a comparator circuit 608 coupled to the PER determination circuit 130 and to the target error rate determination circuit 108. The selection circuit 606 may include a multiplexer (MUX) circuit, as an illustrative example. The comparator circuit 608 may be coupled to the selection circuit 606.

FIG. 6 also illustrates that the communication data rate selection circuit 112 may include a multiplier circuit 610 coupled to the selection circuit 606 and may further include a subtraction circuit 612 coupled to the comparator circuit 608. The communication data rate selection circuit 112 may further include a comparator circuit 614 coupled to the multiplier circuit 610.

During operation, the comparator circuit 608 may receive indications of the plurality of PERs 132 from the PER determination circuit 130. For example, the PER determination circuit 130 may be configured to provide an indication of the first PER 134 to the communication data rate selection circuit 112. In the example of FIG. 6, the plurality of PERs 132 may include n error rates (where n is a positive integer), and the comparator circuit 608 may be configured to receive the n error rates of the plurality of PERs 132.

The target error rate determination circuit 108 may be configured to provide an indication of the target error rate 110 to the communication data rate selection circuit 112. The comparator circuit 608 may be configured to compare each error rate of the plurality of PERs 132 to the target error rate 110 to identify j error rates of the plurality of PERs 132 that are less than or equal to the target error rate 110 (where j is a positive integer, and where j≤n). The comparator circuit 608 may be configured to provide the j error rates to the subtraction circuit 612. The comparator circuit 608 may be configured to provide an indication of the j error rates (e.g., indices associated with the j error rates) to the selection circuit 606.

The selection circuit 606 may be configured to retrieve j communication data rates of the plurality of communication data rates 114 from the memory 150 based on the indication from the comparator circuit 608. For example, instead of retrieving each communication data rate of the plurality of communication data rates 114, the selection circuit 606 may selectively retrieve those communication data rates that correspond to the j error rates identified by the comparator circuit 608.

The subtraction circuit 612 may be configured to receive the j error rates from the comparator circuit 608 and to perform a subtraction operation based on the j error rates to determine a first set of results. For example, the subtraction circuit 612 may be configured to determine, for each rate r of the j communication data rates, 1−PER(r). The subtraction circuit 612 may be configured to provide the first set of results to the multiplier circuit 610.

The multiplier circuit 610 may be configured to receive the j communication data rates from the selection circuit 606 and to receive the first set of results from the subtraction circuit 612. The multiplier circuit 610 may be configured to perform a multiplication operation based on the j communication data rates and the first set of results to generate a second set of results. For example, the multiplier circuit 610 may be configured to determine, for each rate r of the j communication data rates, r*(1−PER(r)). The multiplier circuit 610 may be configured to provide the second set of results to the comparator circuit 614. The second set of results may include a set of values of a metric, such as the first value 162 and the second value 164 of FIG. 1.

The comparator circuit 614 may be configured to select the first communication data rate 116 based on the second set of results. For example, the comparator circuit 614 may be configured to compare the first value 162 to the second value 164 and to select the first communication data rate 116 in response to determining that the first value 162 exceeds the second value 164 (e.g., by selecting the communication data rate r corresponding to max(r*(1−PER(r))). The comparator circuit 614 may be configured to output an indication of the first communication data rate 116, such as an index value associated with the first communication data rate 116. In an illustrative example, the comparator circuit 614 is configured to provide an indication of the first communication data rate 116 to the transmitter 120 of FIG. 1.

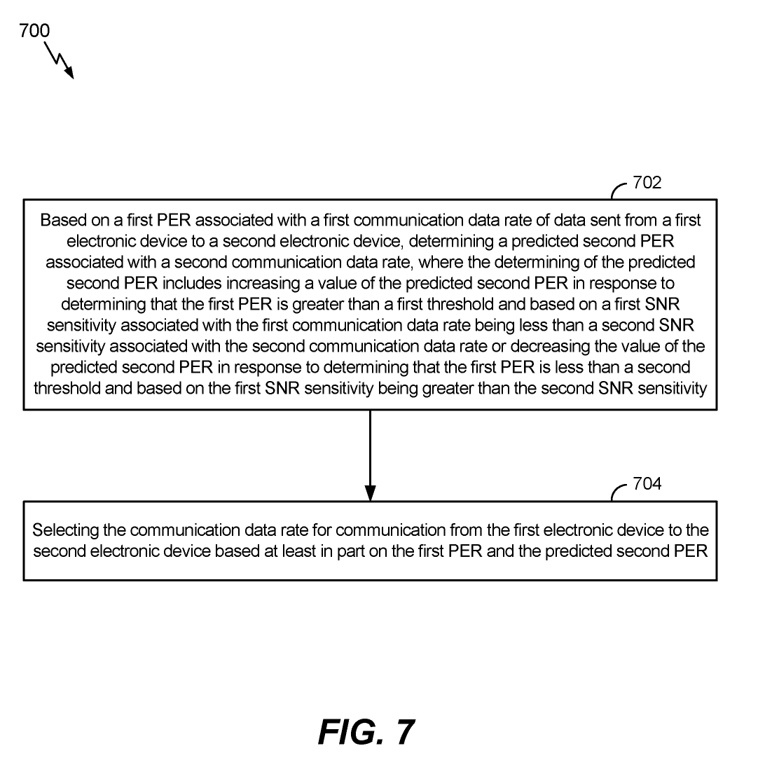

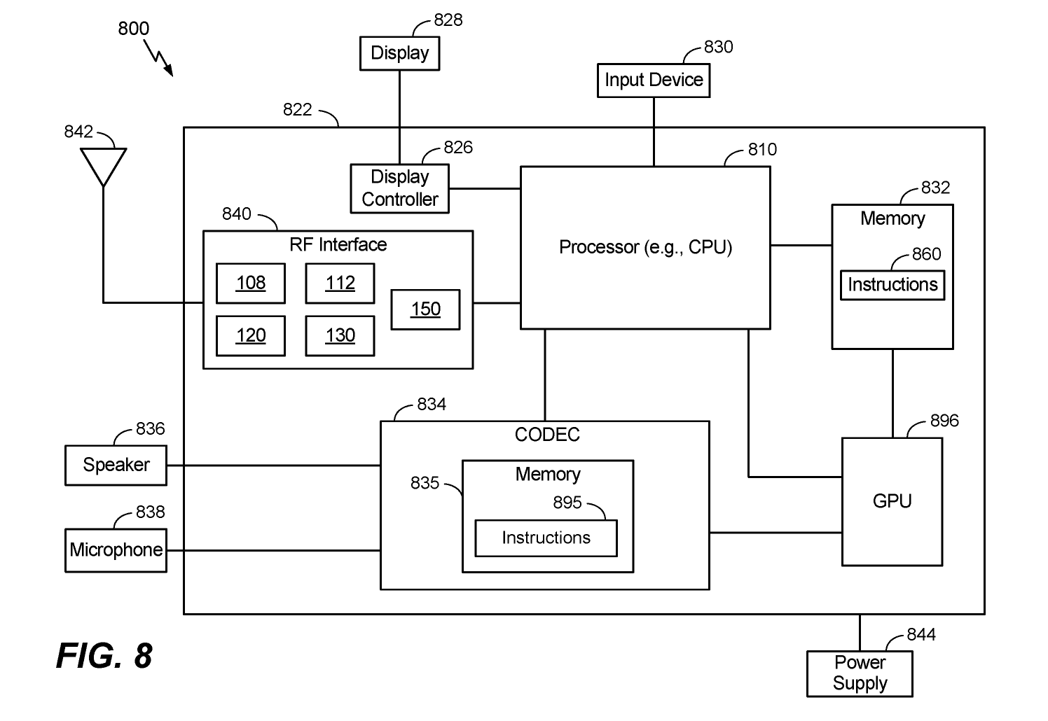

The example of FIG. 6 illustrates that certain operations described herein may be performed, controlled, or initiated using circuitry. Alternatively or in addition, one or more operations described herein may be performed, controlled, or initiated using a processor and processor-executable instructions, as described further with reference to FIGS. 7 and 8.

Referring to FIG. 7, an illustrative example of a method of selecting a communication data rate from a plurality of communication data rates in an OFDMA wireless system is depicted and generally designated 700. The method 700 may be performed by the first electronic device 104 of FIG. 1 to select a communication data rate from the plurality of communication data rates 114 in the system 100, as an illustrative example.

The method 700 includes determining a predicted second PER associated with a second communication data rate, at 702. The predicted second PER is determined based on a first PER associated with a first communication data rate of data sent from a first electronic device to a second electronic device. In a particular example, the PER determination circuit 130 is configured to determine the predicted second PER 139 based on the first PER 134 associated with the first communication data rate 116 of the data 172 sent from the first electronic device 104 to the second electronic device 180.

The determining of the predicted second PER includes increasing a value of the predicted second PER in response to determining that the first PER is greater than a first threshold and based on a first SNR sensitivity associated with the first communication data rate being less than a second SNR sensitivity associated with the second communication data rate or decreasing the value of the predicted second PER in response to determining that the first PER is less than a second threshold and based on the first SNR sensitivity being greater than the second SNR sensitivity. In a particular example, the PER determination circuit 130 is configured to increase the value of second PER 136 to generate the predicted second PER 139 in response to determining that the first PER 134 is greater than the first threshold 122 and based on the first SNR sensitivity 154 being less than the second SNR sensitivity 156 and to decrease the value of second PER 136 to generate the predicted second PER 139 in response to determining that the first PER 134 is less than the second threshold 124 and based on the first SNR sensitivity 154 being greater than the second SNR sensitivity 156.

The method 700 further includes selecting the communication data rate for communication from the first electronic device to the second electronic device based at least in part on the first PER and the predicted second PER, at 704. In a particular example, the communication data rate selection circuit 112 is configured to select the communication data rate (e.g., any of the plurality of communication data rates 114) for communication from the first electronic device 104 to the second electronic device 180 based at least in part on the first PER 134 and the predicted second PER 139.

The method 700 may further include determining whether the first PER (e.g., the first PER 134) and the predicted second PER (e.g., the predicted second PER 139) are less than or equal to a target error rate (e.g., the target error rate 110). In a first illustrative example, the method 700 includes determining that the first PER is less than or equal to a target error rate and determining that the predicted second PER is greater than the target error rate. In this example, the first communication data rate may be selected in response to the first PER being less than or equal to the target error rate and in response to the predicted second PER being greater than the target error rate.

In a second illustrative example, the method 700 includes determining that the first PER is greater than a target error rate and determining that the predicted second PER is less than or equal to the target error rate. In this example, the first communication data rate may be selected in response to the first PER being greater than the target error rate and the predicted second PER being less than or equal to the target error rate.

In a third illustrative example, the method 700 includes determining that the first PER and the predicted second PER are less than or equal to a target error rate. In this example, the method 700 may further include determining, in response to determining that the first PER and the predicted second PER are less than or equal to a target error rate, a first rate adaptation value (e.g., the first value 162) based on the first PER and the first communication data rate determining a second rate adaptation value (e.g., the second value 164) based on the predicted second PER and the second communication data rate. In this example, the method 700 may also include comparing the first rate adaptation value to the second rate adaptation value to identify a highest rate adaptation value, where the selected communication data rate corresponds to the highest rate adaptation value.

The method 700 may include determining, for each particular communication data rate of at least a subset of the plurality of communication data rates, r*(1−PER(r)), where r indicates the particular communication data rate, and where PER(r) indicates a PER associated with the particular communication data rate. The communication data rate may be further selected based on r*(1−PER(r)).

The method 700 may include determining the first SNR sensitivity and the second SNR sensitivity based on one or more unacknowledged packets sent by the first electronic device to the second electronic device. In a particular example, the PER determination circuit 130 is configured to determine the first SNR sensitivity 154 and the second SNR sensitivity 156 based on the indication 174 of one or more errors associated with sending the data 172 from the first electronic device 104 to the second electronic device 180.

The method 700 may include determining that the selected communication data rate is less than or equal to a target error rate, such as the target error rate 110. The method 700 may include selecting the target error rate, such as by selecting the target error rate to increase reliability associated with sending the data 172 from the first electronic device 104 to the second electronic device 180 or to increase throughput associated with sending the data 172 from the first electronic device 104 to the second electronic device 180.

In some examples, one or more operations of the method 700 of FIG. 7 may be performed, initiated, or controlled by a processor that executes instructions. Certain illustrative aspects of a processor that executes instructions are described further with reference to FIG. 8

Referring to FIG. 8, a block diagram of a particular illustrative example of an electronic device is depicted and generally designated 800. In an illustrative example, the electronic device 800 corresponds to the first electronic device 104 (e.g., an access point). Alternatively or in addition, one or more aspects of the electronic device 800 may be implemented within a mobile device (e.g., a cellular phone), a computer (e.g., a server, a laptop computer, a tablet computer, or a desktop computer), a base station, a wearable electronic device (e.g., a personal camera, a head-mounted display, or a watch), a vehicle control system or console, an autonomous vehicle (e.g., a robotic car or a drone), a home appliance, a set top box, an entertainment device, a navigation device, a personal digital assistant (PDA), a television, a monitor, a tuner, a radio (e.g., a satellite radio), a music player (e.g., a digital music player or a portable music player), a video player (e.g., a digital video player, such as a digital video disc (DVD) player or a portable digital video player), a robot, a healthcare device, another electronic device, or a combination thereof.

The electronic device 800 includes one or more processors, such as a processor 810 and a graphics processing unit (GPU) 896. The processor 810 may include a central processing unit (CPU), a DSP, another processing device, or a combination thereof.

The electronic device 800 may further include one or more memories, such as a memory 832. The memory 832 may be coupled to the processor 810, to the GPU 896, or to both. The memory 832 may include random access memory (RAM), magnetoresistive random access memory (MRAM), flash memory, read-only memory (ROM), programmable read-only memory (PROM), erasable programmable read-only memory (EPROM), electrically erasable programmable read-only memory (EEPROM), one or more registers, a hard disk, a removable disk, a compact disc read-only memory (CD-ROM), another memory device, or a combination thereof.

The memory 832 may store instructions 860. The instructions 860 may be executable by the processor 810, by the GPU 896, or by both. The instructions 860 may be executable to perform, initiate, or control one or more operations described with reference to FIGS. 1-7. For example, in some implementations, the instructions 860 are executable by the processor 810 or the GPU 896 to perform operations of the method 700 of FIG. 7.

Alternatively or in addition, one or more operations described with reference to FIGS. 1-7 may be performed by one or more other components of the electronic device 800. For example, the electronic device 800 may include the PER determination circuit 130, the communication data rate selection circuit 112, the transmitter 120, the target error rate determination circuit 108, and the memory 150.

In an illustrative example, the electronic device 800 includes a radio frequency (RF) interface 840 (e.g., a transceiver device) that includes the PER determination circuit 130, the communication data rate selection circuit 112, the transmitter 120, the target error rate determination circuit 108, and the memory 150. The RF interface 840 may be coupled to an antenna 842. In other implementations, one or more of the PER determination circuit 130, the communication data rate selection circuit 112, the transmitter 120, the target error rate determination circuit 108, and the memory 150 may be included in another component of the electronic device 800.

A CODEC 834 can also be coupled to the processor 810. The CODEC 834 may be coupled to one or more microphones, such as a microphone 838. The CODEC 834 may include a memory 835. The memory 835 may store instructions 895 executable by the CODEC 834.

FIG. 8 also shows a display controller 826 that is coupled to the processor 810 and to a display 828. A speaker 836 may be coupled to the CODEC 834.

In a particular example, the processor 810, the GPU 896, the memory 832, the display controller 826, the CODEC 834, and the RF interface 840 are included in a system-on-chip (SoC) device 822. Further, an input device 830 and a power supply 844 may be coupled to the SoC device 822. Moreover, in a particular example, as illustrated in FIG. 8, the display 828, the input device 830, the speaker 836, the microphone 838, the antenna 842, and the power supply 844 are external to the SoC device 822. However, each of the display 828, the input device 830, the speaker 836, the microphone 838, the antenna 842, and the power supply 844 can be coupled to a component of the SoC device 822, such as to an interface or to a controller.

In conjunction with the described embodiments, an apparatus to select a communication data rate from a plurality of communication data rates (e.g., the plurality of communication data rates 114) in an OFDMA wireless system (e.g., the system 100) includes means (e.g., the SNR sensitivity determination circuit 152) for determining a first SNR sensitivity (e.g., the first SNR sensitivity 154) associated with a first communication data rate (e.g., the first communication data rate 116) of data (e.g., the data 172) sent from a first electronic device (e.g., the first electronic device 104) to a second electronic device (e.g., the second electronic device 180) and for determining a second SNR sensitivity (e.g., the second SNR sensitivity 156) associated with a second communication data rate (e.g., the second communication data rate 118) of data sent from the first electronic device to the second electronic device. The apparatus further includes means (e.g., the PER determination circuit 130) for determining, based on a first PER (e.g., the first PER 134) associated with the first communication data rate, a predicted second PER (e.g., the predicted second PER 139) associated with the second communication data rate by increasing a value of the predicted second PER in response to determining that the first PER is greater than a first threshold (e.g., the first threshold 122) and based on the first SNR sensitivity being less than the second SNR sensitivity or by decreasing the value of the predicted second PER in response to determining that the first PER is less than a second threshold (e.g., the second threshold 124) and based on the first SNR sensitivity being greater than the second SNR sensitivity. The apparatus further includes means (e.g., the communication data rate selection circuit 112) for selecting the communication data rate for communication from the first electronic device to the second electronic device based at least in part on the first PER and the predicted second PER. The apparatus may further include means (e.g., the transmitter 120) for sending the data 172 from the first electronic device 104 to the second electronic device 180 at the selected communication data rate. In an illustrative example, the apparatus is integrated within an access point, which may correspond to the first electronic device 104 of FIG. 1.

In conjunction with the described embodiments, a computer-readable medium (e.g., the memory 832) stores instructions (e.g., the instructions 860) executable by a processor (e.g., the processor 810, the GPU 896, or another processor) to cause the processor to perform operations to select a communication data rate from a plurality of communication data rates (e.g., the plurality of communication data rates 114) in an OFDMA wireless system (e.g., the system 100). The operations include determining, based on a first PER (e.g., the first PER 134) associated with a first communication data rate (e.g., the first communication data rate 116) of data (e.g., the data 172) sent from a first electronic device (e.g., the first electronic device 104) to a second electronic device (e.g., the second electronic device 180), a predicted second PER (e.g., the predicted second PER 136) associated with a second communication data rate (e.g., the second communication data rate 118). Determining the predicted second PER includes either increasing a value of the predicted second PER in response to determining that the first PER is greater than a first threshold (e.g., the first threshold 122) and based on a first SNR sensitivity (e.g., the first SNR sensitivity 154) associated with the first communication data rate being less than a second SNR sensitivity (e.g., the second SNR sensitivity 156) associated with the second communication data rate or decreasing the value of the predicted second PER in response to determining that the first PER is less than a second threshold (e.g., the second threshold 124) and based on the first SNR sensitivity being greater than the second SNR sensitivity. The operations further include selecting the communication data rate for communication from the first electronic device to the second electronic device based at least in part on the first PER and the predicted second PER.

As used herein, “coupled” may include communicatively coupled, electrically coupled, magnetically coupled, physically coupled, optically coupled, and combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc.

As used herein, “generating,” “calculating,” “using,” “selecting,” “accessing,” and “determining” may be used interchangeably. For example, “generating,” “calculating,” or “determining” a value, a characteristic, a parameter, or a signal may refer to actively generating, calculating, or determining a value, a characteristic, a parameter, or a signal or may refer to using, selecting, or accessing a value, a characteristic, a parameter, or a signal that is already generated, such as by a component or a device.

The foregoing disclosed devices and functionalities may be designed and represented using computer files (e.g. RTL, GDSII, GERBER, etc.). The computer files may be stored on computer-readable media. Some or all such files may be provided to fabrication handlers who fabricate devices based on such files. Resulting products include wafers that are then cut into die and packaged into integrated circuits (or “chips”). The integrated circuits are then employed in electronic devices, such as one or more of the first electronic device 104 of FIG. 1, the second electronic device 180 of FIG. 1, or the electronic device 800 of FIG. 8.

The various illustrative logical blocks, configurations, modules, circuits, and algorithm steps described in connection with the examples disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

One or more operations of a method or algorithm described herein may be embodied directly in hardware, in a software module executed by a processor, or in a combination of the two. For example, one or more operations of the method 700 of FIG. 7 may be initiated, controlled, or performed by a field-programmable gate array (FPGA) device, an application-specific integrated circuit (ASIC), a processing unit such as a central processing unit (CPU), a digital signal processor (DSP), a controller, another hardware device, a firmware device, or a combination thereof. A software module may reside in random access memory (RAM), magnetoresistive random access memory (MRAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transitory storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed examples is provided to enable a person skilled in the art to make or use the disclosed examples. Various modifications to these examples will readily apparent to those skilled in the art, and the principles defined herein may be applied to other examples without departing from the scope of the disclosure. Thus, the present disclosure is not intended to be limited to the examples shown herein but is to be accorded the widest scope possible consistent with the principles and novel features as defined by the following claims.

What is claimed is:

1. A method of selecting a communication data rate from a plurality of communication data rates in an orthogonal frequency division multiple access (OFDMA) wireless system, the method comprising:
based on a first packet error rate (PER) associated with a first communication data rate of data sent from a first electronic device to a second electronic device, determining a predicted second PER associated with a second communication data rate, wherein the determining of the predicted second PER includes:
in response to determining that the first PER is greater than a first threshold, based on a first signal-to-noise ratio (SNR) sensitivity associated with the first communication data rate being less than a second SNR sensitivity associated with the second communication data rate, increasing a value of the predicted second PER; or
in response to determining that the first PER is less than a second threshold, based on the first SNR sensitivity being greater than the second SNR sensitivity, decreasing the value of the predicted second PER; and
selecting the communication data rate for communication from the first electronic device to the second electronic device based at least in part on the first PER and the predicted second PER.

2. The method of claim 1, further comprising:
determining that the first PER is less than or equal to a target error rate; and
determining that the predicted second PER is greater than the target error rate,
wherein the first communication data rate is selected as the selected communication data rate in response to the first PER being less than or equal to the target error rate and the predicted second PER being greater than the target error rate.

3. The method of claim 1, further comprising:
determining that the first PER is greater than a target error rate; and
determining that the predicted second PER is less than or equal to the target error rate,
wherein the first communication data rate is selected as the selected communication data rate in response to the first PER being greater than the target error rate and the predicted second PER being less than or equal to the target error rate.

4. The method of claim 1, further comprising:
in response to determining that the first PER and the predicted second PER are less than or equal to a target error rate:
determining a first rate adaptation value based on the first PER and the first communication data rate;
determining a second rate adaptation value based on the predicted second PER and the second communication data rate; and
comparing the first rate adaptation value to the second rate adaptation value to identify a highest rate adaptation value, wherein the selected communication data rate corresponds to the highest rate adaptation value.

5. The method of claim 1, further comprising determining, for each particular communication data rate of at least a subset of the plurality of communication data rates, r*(1−PER(r)), wherein r indicates the particular communication data rate, and wherein PER(r) indicates a PER associated with the particular communication data rate.

6. The method of claim 5, wherein the communication data rate is further selected based on r*(1−PER(r)).

7. The method of claim 1, further comprising determining the first SNR sensitivity and the second SNR sensitivity based on one or more unacknowledged packets sent by the first electronic device to the second electronic device.

8. The method of claim 7, further comprising determining that the selected communication data rate is less than or equal to a target error rate.

9. The method of claim 8, further comprising selecting the target error rate to increase reliability associated with sending the data from the first electronic device to the second electronic device.

10. The method of claim 8, further comprising selecting the target error rate to increase throughput associated with sending the data from the first electronic device to the second electronic device.

11. An apparatus to select a communication data rate from a plurality of communication data rates in an orthogonal frequency division multiple access (OFDMA) wireless system, the apparatus comprising:
a signal-to-noise ratio (SNR) sensitivity determination circuit configured to determine a first SNR sensitivity associated with a first communication data rate of data sent from a first electronic device to a second electronic device and to determine a second SNR sensitivity associated with a second communication data rate of data sent from the first electronic device to the second electronic device;
a packet error rate (PER) determination circuit coupled to an output of the SNR sensitivity determination circuit, the PER determination circuit configured to determine, based on a first PER associated with the first communication data rate, a predicted second PER associated with the second communication data rate, wherein the PER determination circuit is further configured to increase a value of the predicted second PER in response to determining that the first PER is greater than a first threshold and based on the first SNR sensitivity being less than the second SNR sensitivity and to decrease the value of the predicted second PER in response to determining that the first PER is less than a second threshold and based on the first SNR sensitivity being greater than the second SNR sensitivity; and
a communication data rate selection circuit coupled to an output of the PER determination circuit, the communication data rate selection circuit configured to select the communication data rate for communication from the first electronic device to the second electronic device based at least in part on the first PER and the predicted second PER.

12. The apparatus of claim 11, further comprising a transmitter coupled to the communication data rate selection circuit, the transmitter configured to send data to the second electronic device based on the communication data rate.

13. The apparatus of claim 11, further comprising a memory coupled to the communication data rate selection circuit, the memory configured to store indications of the plurality of communication data rates.

14. The apparatus of claim 11, further comprising a target error rate determination circuit coupled to the communication data rate selection circuit, the target error rate determination circuit configured to provide an indication of a target error rate to the communication data rate selection circuit.

15. The apparatus of claim 14, wherein the communication data rate selection circuit is further configured to select the communication data rate based on the target error rate.

16. A computer-readable medium storing instructions executable by a processor to initiate operations to select a communication data rate from a plurality of communication data rates in an orthogonal frequency division multiple access (OFDMA) wireless system, the operations comprising:
based on a first packet error rate (PER) associated with a first communication data rate of data sent from a first electronic device to a second electronic device, determining a predicted second PER associated with a second communication data rate, wherein the determining of the predicted second PER includes:
in response to determining that the first PER is greater than a first threshold, based on a first signal-to-noise ratio (SNR) sensitivity associated with the first communication data rate being less than a second SNR sensitivity associated with the second communication data rate, increasing a value of the predicted second PER; or
in response to determining that the first PER is less than a second threshold, based on the first SNR sensitivity being greater than the second SNR sensitivity, decreasing the value of the predicted second PER; and
selecting the communication data rate for communication from the first electronic device to the second electronic device based at least in part on the first PER and the predicted second PER.

17. The computer-readable medium of claim 16, wherein the operations further comprise sending data from the first electronic device to the second electronic device at the selected communication data rate.

18. The computer-readable medium of claim 16, wherein the operations further comprise:
determining that the first PER is less than or equal to a target error rate; and
determining that the predicted second PER is greater than the target error rate,
wherein the first communication data rate is selected as the selected communication data rate in response to the first PER being less than or equal to the target error rate and the predicted second PER being greater than the target error rate.

19. The computer-readable medium of claim 16, wherein the operations further comprise:
determining that the first PER is greater than a target error rate; and
determining that the predicted second PER is less than or equal to the target error rate,
wherein the first communication data rate is selected as the selected communication data rate in response to the first PER being greater than the target error rate and the predicted second PER being less than or equal to the target error rate.

20. The computer-readable medium of claim 16, wherein the operations further comprise:
in response to determining that the first PER and the predicted second PER are less than or equal to a target error rate:
determining a first rate adaptation value based on the first PER and the first communication data rate;
determining a second rate adaptation value based on the predicted second PER and the second communication data rate; and
comparing the first rate adaptation value to the second rate adaptation value to identify a highest rate adaptation value, wherein the selected communication data rate corresponds to the highest rate adaptation value.

21. An apparatus to select a communication data rate from a plurality of communication data rates in an orthogonal frequency division multiple access (OFDMA) wireless system, the apparatus comprising:
means for determining a first signal-to-noise ratio (SNR) sensitivity associated with a first communication data rate of data sent from a first electronic device to a second electronic device and for determining a second SNR sensitivity associated with a second communication data rate of data sent from the first electronic device to the second electronic device;
means for determining, based on a first packet error rate (PER) associated with the first communication data rate, a predicted second PER associated with the second communication data rate by increasing a value of the predicted second PER in response to determining that the first PER is greater than a first threshold and based on the first SNR sensitivity being less than the second SNR sensitivity or by decreasing the value of the predicted second PER in response to determining that the first PER is less than a second threshold and based on the first SNR sensitivity being greater than the second SNR sensitivity; and
means for selecting the communication data rate for communication from the first electronic device to the second electronic device based at least in part on the first PER and the predicted second PER.

22. The apparatus of claim 21, further comprising means for sending data from the first electronic device to the second electronic device at the selected communication data rate.
